(19) United States
(12) Patent Application Publication
(10) Pub. No.: US 2024/0087078 A1
(43) Pub. Date: Mar. 14, 2024

(54) TWO-LEVEL PRIMITIVE BATCH BINNING WITH HARDWARE STATE COMPRESSION

(71) Applicant: Advanced Micro Devices, Inc., Santa Clara, CA (US)

(72) Inventors: Alexander Fuad Ashkar, Orlando, FL (US); Vishrut Vaibhav, Orlando, FL (US); Manu Rastogi, Orlando, FL (US); Harry J. Wise, Orlando, FL (US)

(73) Assignee: Advanced Micro Devices, Inc., Santa Clara, CA (US)

(21) Appl. No.: 18/337,322

(22) Filed: Jun. 19, 2023

Related U.S. Application Data
(60) Provisional application No. 63/406,578, filed on Sep. 14, 2022.

(51) Int. Cl. G06T 1/60; G06T 1/20; G06T 15/00; G06T 15/40

(52) U.S. Cl. CPC G06T 1/60; G06T 1/20; G06T 15/005; G06T 15/40

(57) ABSTRACT

Methods, devices, and systems for rendering primitives in a frame. During a visibility pass, state packets are processed to determine a register state, and the register state is stored in a memory device. During a rendering pass, the state packets are discarded and the register state is read from the memory device. In some implementations, a graphics pipeline is configured during the visibility pass based on the register state determined by processing the state packets, and the graphics pipeline is configured during the rendering pass based on the register state read from the memory device. In some implementations, replay control packets, draw packets, and the state packets, from a packet stream, are processed during the visibility pass; the draw packets are modified based on visibility information determined during the visibility pass; and the replay control packets and draw packets are processed, during the rendering pass.

### CROSS-REFERENCE TO RELATED APPLICATIONS

This application claims the benefit of U.S. Provisional application No. 63/406,578, filed on Sep. 14, 2022, the entirety of which is hereby incorporated herein by reference.

### BACKGROUND

In computer graphics, objects are typically represented as a group of polygons, which are typically referred to as primitives in this context. The polygons are typically triangles, each represented by three vertices. Other types of polygon primitives are used in some cases, however triangles are the most common example. Each vertex includes information defining a position in three-dimensional (3D) space, and in some implementations, includes other information, such as color, normal vector, and/or texture information, for example.

In typical graphics processing, a three-dimensional (3D) scene is rendered onto a two-dimensional (2D) screen. To render the scene, graphics processing commands are received (e.g., from an application) and computation tasks are provided (e.g., to an accelerated processing device, such as a GPU) for execution of the tasks. The 3D scene to be rendered is made up of primitives (e.g., triangles, quadrilaterals or other geometric shapes).

Binning (or tiling) is a technique which splits the frame into sections (e.g., tiles or bins) and renders primitives overlapping one bin of a frame before rendering another bin of the frame.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating a graphics processing pipeline, according to an example;

FIG. 4 is a block diagram of an example frame divided into bins;

FIG. 5 is a block diagram illustrating example visibility pass data flow;

FIG. 6 is a block diagram illustrating example render pass data flow; and

FIG. 7 is a flow chart illustrating the example visibility pass and example render pass of FIGS. 5 and 6.

### DETAILED DESCRIPTION

In some implementations, it is advantageous to render an entire frame in subsets, which may be referred to as bins or tiles. For example, in some implementations, the frame is divided into bins in the x-y plane and only primitives covered by pixels of a first bin are rendered before moving on to the next bin. This approach is referred to as binning for convenience. In some cases this has the advantage of increasing cache locality and data reuse during rendering, reducing the eviction rate of the rendering data from the cache.

Some implementations provide a method for rendering primitives in a frame. During a visibility pass, state packets are processed to determine a register state, and the register state is stored in a memory device. During a rendering pass, the state packets are discarded and the register state is read from the memory device.

In some implementations, a graphics pipeline is configured during the visibility pass based on the register state determined by processing the state packets, and the graphics pipeline is configured during the rendering pass based on the register state read from the memory device. In some implementations, replay control packets, draw packets, and the state packets, from a packet stream, are processed during the visibility pass; the draw packets are modified based on visibility information determined during the visibility pass; and the replay control packets and draw packets are processed, during the rendering pass.

In some implementations, the register state is stored in an encoded format. In some implementations, the register state is stored in a compressed format. In some implementations, the register state is stored in a cache memory or random-access memory (RAM). In some implementations, the state packets are processed to determine the register state by a packet processor, and the packet processor sends the register state to acceleration hardware for storage in the memory device.

Some implementations provide a graphics processing device configured to render primitives in a frame. The graphics processing device includes circuitry configured to process state packets to determine a register state and store the register state in a memory device, during a visibility pass. The graphics processing device also includes circuitry configured to discard the state packets and read the register state from the memory device, during a rendering pass.

In some implementations, the graphics processing device includes circuitry configured to configure a graphics pipeline during the visibility pass based on the register state determined by processing the state packets; and circuitry configured to configure the graphics pipeline during the rendering pass based on the register state read from the memory device. In some implementations, the graphics processing device includes circuitry configured to process replay control packets, draw packets, and the state packets, from a packet stream, during the visibility pass; and circuitry configured to modify the draw packets based on visibility information determined during the visibility pass, and to process modified draw packets and the replay control packets, during the rendering pass. In some implementations, the graphics processing device includes circuitry configured to encode the register state and to store the register state in an encoded format. In some implementations, the graphics processing device includes circuitry configured to compress the register state and to store the register state in a compressed format. In some implementations, the graphics processing device includes circuitry configured to store the register state in a cache memory or random-access memory (RAM). In some implementations, the graphics processing device includes circuitry configured to process the state packets to determine the register state, and circuitry configured to send the register state to acceleration hardware for storage in the memory device.

Some implementations provide an acceleration device. The acceleration device includes circuitry configured to receive register state from a packet processor and to store the register state in a memory device, during a visibility pass. The acceleration device also includes circuitry configured to read the register state from the memory device during a rendering pass.

In some implementations, the acceleration device includes circuitry configured to configure a graphics pipeline during the visibility pass based on the register state received from the packet processor; and circuitry configured to configure the graphics pipeline during the rendering pass based on the register state read from the memory device. In some implementations, the acceleration device includes circuitry configured to send register state received from the packet processor to a graphics pipeline during the visibility pass; and circuitry configured to send register state read from the memory device to the graphics pipeline during the rendering pass. In some implementations, the acceleration device includes circuitry configured to encode the register state and to store the register state in an encoded format. In some implementations, the acceleration device includes circuitry configured to compress the register state and to store the register state in a compressed format. In some implementations, the acceleration device includes circuitry configured to store the register state in a cache memory or random-access memory (RAM).

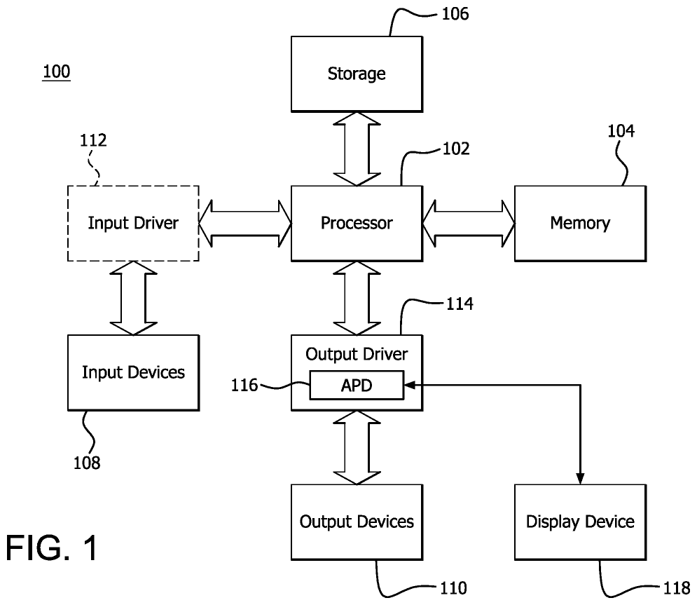

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm can also perform the functionality described herein.

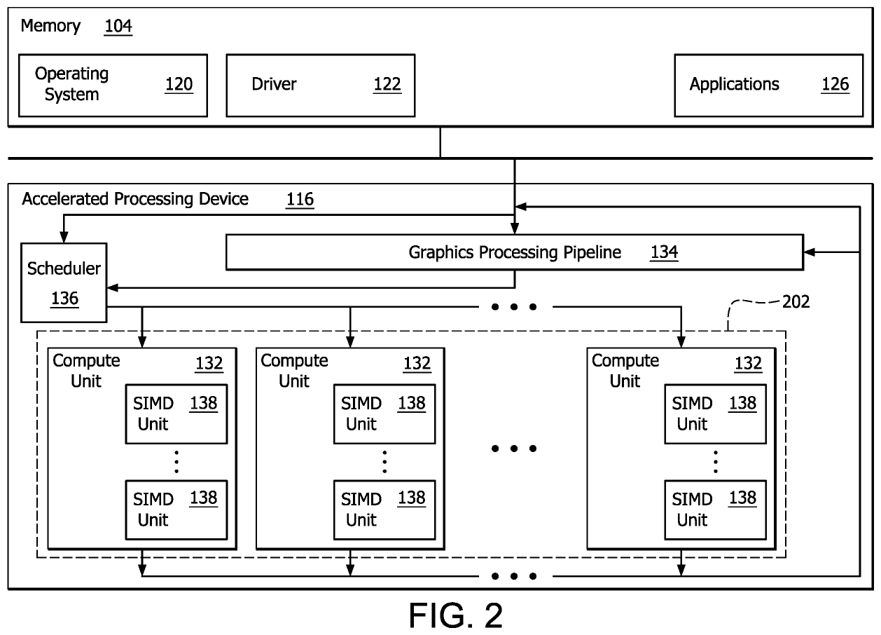

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with or using different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

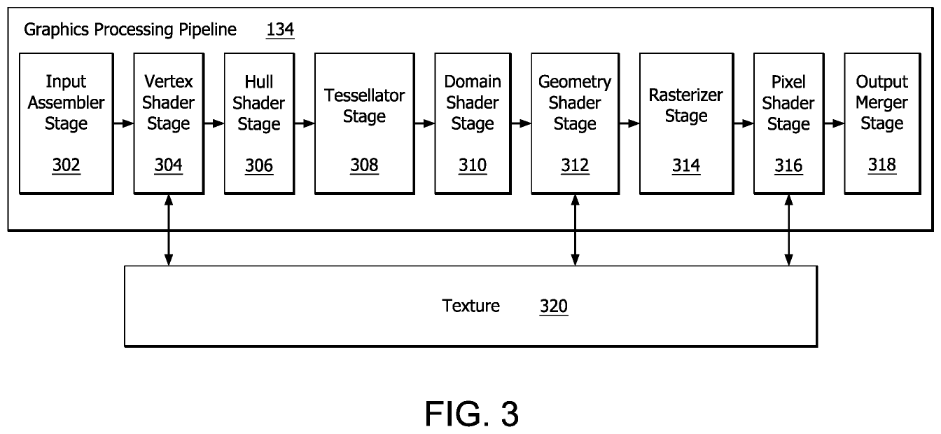

FIG. 3 is a block diagram showing additional details of the graphics processing pipeline 134 illustrated in FIG. 2. The graphics processing pipeline 134 includes logical stages that each performs specific functionality. The stages represent subdivisions of functionality of the graphics processing pipeline 134. Each stage is implemented partially or fully as shader programs executing in the programmable processing units 202, or partially or fully as fixed-function, non-programmable hardware external to the programmable processing units 202.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertexes of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations. Herein, such transformations are considered to modify the coordinates or “position” of the vertices on which the transforms are performed. Other operations of the vertex shader stage 304 modify attributes other than the coordinates.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the programmable processing units 202.

The geometry shader stage 312 performs vertex operations on a primitive-by-primitive basis. A variety of different types of operations can be performed by the geometry shader stage 312, including operations such as point sprint expansion, dynamic particle system operations, fur-fin generation, shadow volume generation, single pass render-to-cubemap, per-primitive material swapping, and per-primitive material setup. In some instances, a shader program that executes on the programmable processing units 202 perform operations for the geometry shader stage 312.

The rasterizer stage 314 accepts and rasterizes simple primitives and generated upstream. Rasterization includes determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a shader program that executes on the programmable processing units 202.

The output merger stage 318 accepts output from the pixel shader stage 316 and merges those outputs, performing operations such as z-testing and alpha blending to determine the final color for a screen pixel.

Texture data, which defines textures, are stored and/or accessed by the texture unit 320. Textures are bitmap images that are used at various points in the graphics processing pipeline 134. For example, in some instances, the pixel shader stage 316 applies textures to pixels to improve apparent rendering complexity (e.g., to provide a more “photorealistic” look) without increasing the number of vertices to be rendered.

In some instances, the vertex shader stage 304 uses texture data from the texture unit 320 to modify primitives to increase complexity, by, for example, creating or modifying vertices for improved aesthetics. In one example, the vertex shader stage 304 uses a height map stored in the texture unit 320 to modify displacement of vertices. This type of technique can be used, for example, to generate more realistic looking water as compared with textures only being used in the pixel shader stage 316, by modifying the position and number of vertices used to render the water. In some instances, the geometry shader stage 312 accesses texture data from the texture unit 320.

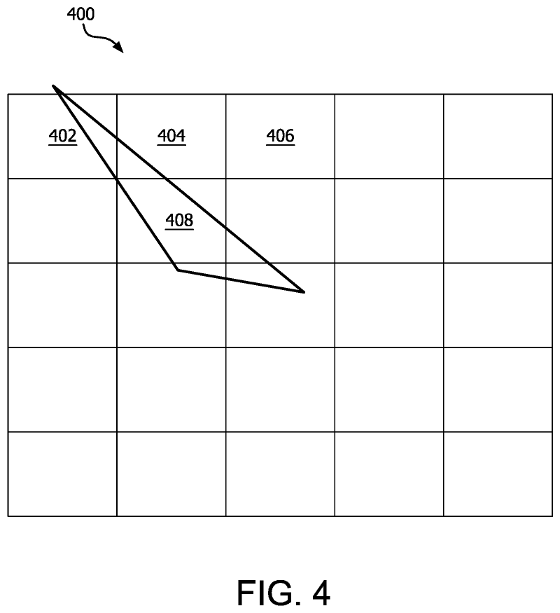

FIG. 4 is a block diagram of an example frame 400 divided into bins. Frame 400 is divided into 25 bins in this example, although any suitable number of bins is possible. For convenience, only three of the bins, 402,404, and 406 are labeled. Using a binning approach, only those primitives of frame 400 that are covered by pixels falling within bin 402 are rendered to begin with. An example primitive 408 is shown, which is covered by bin 402. After those primitives rasterizing to pixels falling within bin 402 are rendered, primitives rasterizing to pixels falling within bin 404 are rendered, and so forth to bin 406 and then to the other bins, until primitives rasterizing to pixels falling within each of the bins of frame 400 have been rendered.

In some implementations, a subset of primitives, referred to as a batch, is rendered with respect to each of the bins, one bin at a time. This approach may be referred to as primitive batch binning (PBB). This may be done, for example, in order to achieve cache locality and data reuse improvements. For each bin, batch primitives are each first rasterized to determine whether they are covered by pixels of a bin, after which the batch primitives determined to be covered by pixels of the bin are dispatched for rendering. In some implementations, this determination is made using a rasterization algorithm. The rasterization algorithm is part of the PBB in some implementations. After a batch has been rendered for each bin, one bin at a time, the next batch of primitives is rendered for each bin in the same way, one bin at a time, until all batches have been rasterized and rendered for all bins.

Two level primitive batch binning (TLPBB) is a rendering technique where primitives overlapping one bin of a frame are rendered in two passes in order to reduce the computation burden based on visibility of the primitives.

In a first, visibility pass (in some cases, referred to as a Z pre-pass (ZPP)), the primitives are processed by a graphics pipeline (e.g., graphics processing pipeline 134 as shown and described with respect to FIGS. 2 and 3) to determine whether they are visible in the rendered 2D scene. The visibility pass rasterizes overlapping primitives (e.g., of a batch, or which overlap pixels in a bin) once without color calculations (or shading, or other rendering calculations) to determine the “Z” or depth order of the primitives (i.e., which primitive is closest to the viewer, or alternatively, which primitive is furthest away, depending on Z function). In some implementations, the Z, depth order, or visibility information is recorded in a buffer for each sample.

In a second, rendering pass, the primitives that were determined to be visible in the first pass are rendered by re-executing or “replaying” the rendering commands to the graphics pipeline. More than one rendering pass may be executed.

For example, in some implementations, after the sample closest to the viewer has been determined in the visibility pass, the primitives are replayed in a second pass to the rendering pipeline for color calculations (or shading, or other rendering calculations), along with the visibility, depth, or Z information (e.g., using circuitry configured to provide the replay functionality). Based on the visibility, depth, or Z information, the color, shading, or other rendering calculations are only performed for the sample that is at the front (i.e., closest to and/or visible to the viewer). In some implementations, this has the advantage of improving performance by reducing processing load.

Conventionally, rendering commands are executed by a packet processor to process state and draw packets for the first pass, and executed again for the second pass, increasing the amount of processing that is needed as compared with one-pass techniques.

Accordingly, some implementations accelerate the TLPBB replay by minimizing packet processing during subsequent passes, using processing hardware referred to as a hardware state acceleration engine herein.

For example, in some implementations, during the visibility pass, register state is determined by processing state packets, and the register state is provided to the rendering pipeline. The hardware state acceleration engine “shadows” (i.e., copies) the register state sent to the hardware, e.g., in an encoded and compressed format relative to the command stream. In other words, the register state that is determined during the visibility pass is stored in a cache, random access memory (RAM), or other suitable memory device (e.g., in a compressed and/or encoded format). This memory is also referred to, for convenience herein, as a shadow memory/cache. In this context, register state refers to the configuration of the hardware of the graphics pipeline for subsequent draw operations.

During the rendering pass (or passes), the hardware state acceleration engine “replays” (i.e., provides) the register state information to the graphics pipeline from the cache, RAM, or other suitable memory device, instead of the packet processor re-processing the state packets and providing the register state information to the graphics pipeline.

In some implementations, this has the advantage of accelerating the rendering by not processing the state packets over again. In some implementations, replaying the encoded/compressed state data from a hardware acceleration engine provides a performance boost for the remaining replay control loops (i.e., rendering passes after the visibility pass).

In some implementations, these subsequent loops (i.e., rendering passes after the visibility pass) have performance higher than would be measured if the processor processed the packets individually.

In conventional systems, a packet processor executes a sequence of state/draw packets in a loop using visibility information provided from the graphics pipeline as part of TLPBB. This process is broken up into a visibility pass and a rendering pass.

During the visibility pass, the command processor processes the entire sequence of state packets and draw packets. In some implementations, during the visibility pass, the hardware state acceleration engine may store (e.g., in a compressed and/or encoded format) all of the state used in the visibility pass, and insert draw marker tokens inside the memory to indicate when the draw packet was processed.

In order to store the state data in the state shadow memory/cache, in some implementations, the hardware state acceleration engine “snoops” (i.e., copies) the outgoing register writes that are going from the packet processor to the register bus path, and then, in some implementations, stores (and in some implementations, encodes and/or processes) the transactions into the shadow memory/cache. Table 1 illustrates example packet processing during the visibility pass. In the example of Table 1, SET_SH_REG and SET_CONTEXT_REG are state packets, and DRAW PACKET is a draw packet.

TABLE 1

OUTPUT

| | | |
|---|---|---|
| | Compressed State | |
| | and Draw Tokens | Packet Sent to |
| | Stored to Shadow | Hardware State |
| INPUT | Memory | Acceleration Engine |

| Packet Processed on | Token | | on Visibility Pass (all |
|---|---|---|---|
| Visibility Pass | Type | Payload | packets) |
| REPLAY CONTROL | — | — | REPLAY CONTROL |
| (begin) | | | |
| SET_SH_REG | SH | Offset, Data | SET_SH_REG |
| | State | | |
| SET_SH_REG | SH | Offset, Data | SET_SH_REG |
| | State | | |
| SET_CONTEXT_REG | Context | Offset, Data | SET_CONTEXT_REG |
| | State | | |
| DRAW PACKET | Draw | — | DRAW PACKET |
| | Token | | |
| SET_SH_REG | SH | Offset, Data | SET_SH_REG |
| | State | | |
| SET_SH_REG | SH | Offset, Data | SET_SH_REG |
| | State | | |
| SET_CONTEXT_REG | Context | Offset, Data | SET_CONTEXT_REG |
| | State | | |
| DRAW PACKET | Draw | — | DRAW PACKET |
| | Token | | |
| REPLAY CONTROL | — | — | REPLAY CONTROL |
| (end) | | | |

In some implementations, during the rendering pass, the packet processor discards the render state packets and processes only the Replay Control and Draw packets. In some implementations, the packet processor pairs the draw packets with the visibility info to modify the draw packets for the render pass.

Table 2 illustrates example packet processing during the rendering pass.

TABLE 2

| INPUT | |
|---|---|
| Packet Processed by | |
| packet processor on | |
| Rendering Pass | OUTPUT |
| (State packets discarded | Packet Sent to Graphics |
| by packet processing | Processing Pipeline on |
| hardware) | Rendering Pass |
| REPLAY_CONTROL | REPLAY_CONTROL |
| (begin) | |
| DRAW PACKET | DRAW PACKET |
| | w/Visibility mods |
| DRAW PACKET | DRAW PACKET |
| | w/Visibility mods |
| REPLAY_CONTROL | REPLAY_CONTROL |
| (end) | |

In some implementations, at draw packet boundaries, the packet processor commands the hardware state acceleration engine to read out the memory/cache starting at the read pointer and write the register bus with the shadowed state. In some implementations, the packet processor applies the correct context to any context writes. In some implementations, the hardware state acceleration engine continues to process state out of the state shadow memory/cache RAM until it encounters another draw packet marker before stopping. In some implementations, at the draw packet marker, the hardware state acceleration engine waits for a command from the packet processor to continue. In some implementations, the modified draw packets are processed by the ME in sync with the hardware state acceleration engine to ensure a visible draw or dummy draw is written to the register bus with the proper context and applied to the accumulated render state written by the hardware state acceleration engine. In some implementations, the hardware state acceleration engine continues to process state and draw packet markers until the read pointer matches the write pointer in the memory/cache, indicating that the loop is complete.

Table 3 illustrates example handling of stored state during the rendering pass.

TABLE 3

| | |
|---|---|
| | Compressed State & Draw Tokens |
| Packet Processed | Processed by the Hardware State |
| by packet | Acceleration Engine on Rendering |
| processor on | Pass |

| Rendering Pass | Token Type | Payload |
|---|---|---|
| REPLAY_CONTROL | — | — |
| — | SH State | Offset, Data |
| — | SH State | Offset, Data |
| — | Context State | Offset, Data |
| DRAW PACKET | Draw Token | — |
| — | SH State | Offset, Data |
| — | SH State | Offset, Data |
| — | Context State | Offset, Data |
| DRAW PACKET | Draw Token | — |
| REPLAY_CONTROL | — | — |

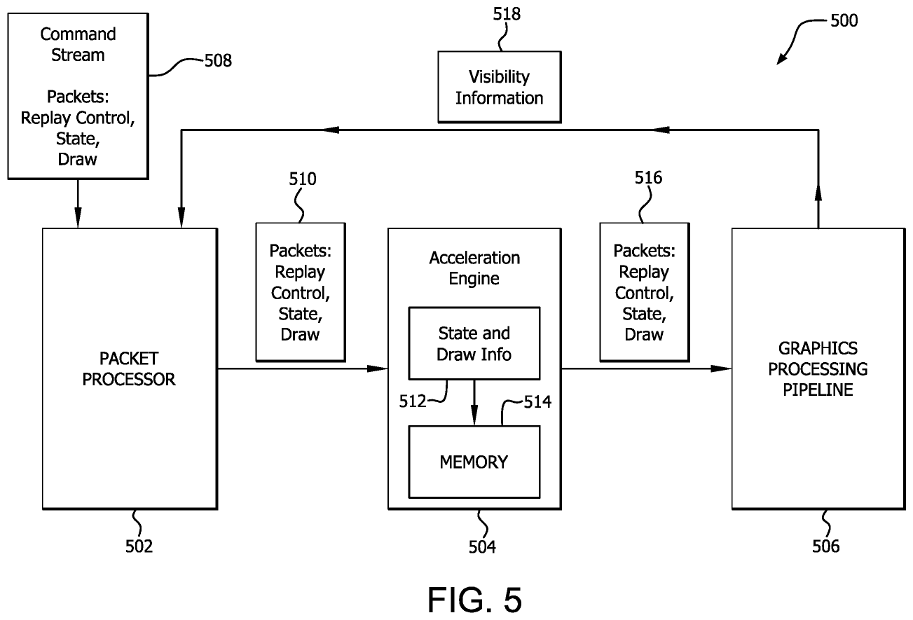

FIG. 5 is a block diagram illustrating example visibility pass data flow 500 for a visibility pass, e.g., as described above. Visibility pass data flow 500 shows a packet processor 502, hardware state acceleration engine 504, and graphics processing pipeline 506.

In visibility pass data flow 500, the packet processor 502 receives a command stream which includes replay control, state, and draw packets 508, and processes the state and draw packets to determine render state and draw tokens, respectively. Packet processor 502 passes the processed packets 510, and render state and draw tokens, to hardware state acceleration engine 504, which stores the render state and draw tokens 512 in a shadow cache 514. The shadow cache is shown as implemented within the hardware state acceleration engine 504 in this example, however in some implementations it is implemented in any suitable location, such as outside the hardware state acceleration engine 504. Some implementations include hardware configured to decompose the command stream into a compressed format that is shadowed (i.e., copied) to a local memory (e.g., a cache memory, such as a dedicated shadow cache or other suitable memory) during the Visibility Pass. In this context, decompose refers to breaking down the command packet sequence into a form that can be saved in the shadow cache/memory. In some implementations, the command stream is compressed by stripping off packet headers and using tokens to identify render state and draw initiators).

Hardware state acceleration engine 504 passes the determined render state, and the replay control and draw packets 516 to graphics processing pipeline 506. Graphics processing pipeline 506 processes the draw packets based on the render state received from the hardware state acceleration engine 504 to determine visibility information 518. Visibility information 518 is fed back to packet processor 502 to be used in the render pass.

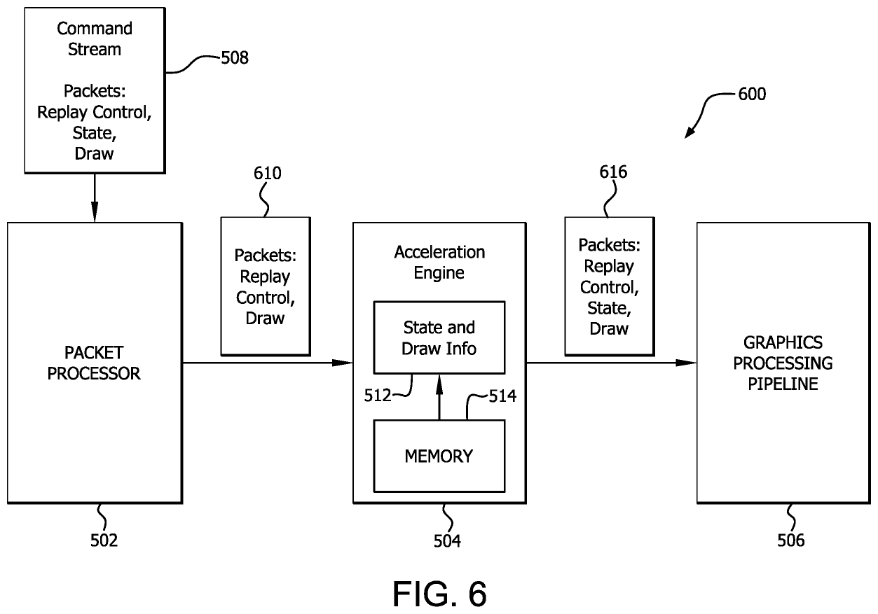

FIG. 6 is a block diagram illustrating example render pass data flow 600 for a render pass, e.g., as described above. Render pass data flow 600 shows packet processor 502, hardware state acceleration engine 504, and graphics processing pipeline 506, as shown and described with respect to FIG. 5.

In the render pass data flow 600 the packet processor 502 receives the same command stream which includes replay control, state, and draw packets 508. Packet processor 502 discards or ignores the state packets, and modifies the draw packets based on the visibility information 518 received during visibility pass 500 as shown and described with respect to FIG. 5.

Packet processor 502 passes the processed replay control and draw packets 610 to hardware state acceleration engine 504, which retrieves the render state and draw tokens 512 that were stored in shadow cache 514 during visibility pass 500 as shown and described with respect to FIG. 5. In some implementations, the render state and draw tokens 512 are decompressed after they are retrieved. In some implementations, hardware state acceleration engine 504 retrieves the render state and draw tokens 512 from the state shadow memory and replays the sequence without fetching the packets again from external memory. In some implementation, this is based on commands from the packet processor 502, such as the replay control packets.

Hardware state acceleration engine 504 passes the retrieved render state, and the replay control and draw packets 616 to graphics processing pipeline 506. Graphics processing pipeline 506 processes the draw packets based on the render state received from the hardware state acceleration engine 504 to render the primitives defined in the command stream (e.g., by performing color calculations or shading, etc.).

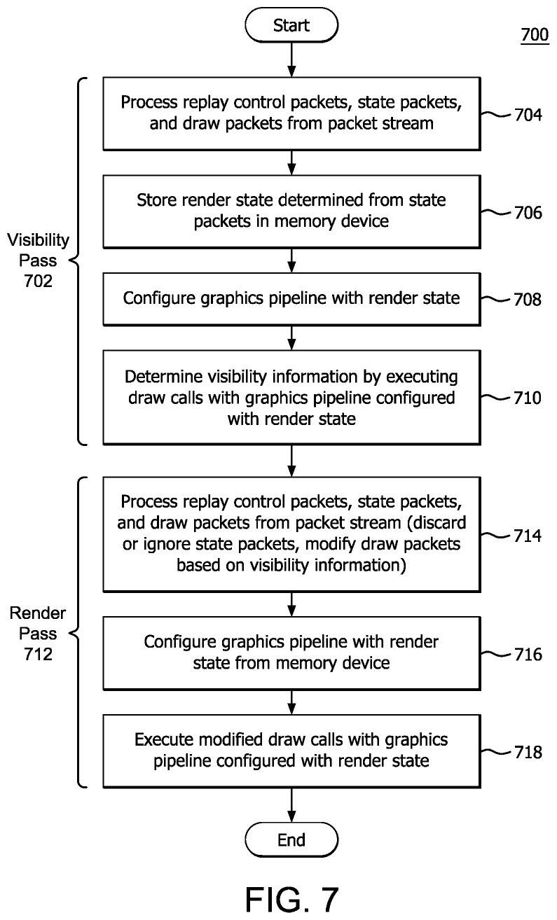

FIG. 7 is a flow chart illustrating an example method 700 for two level primitive batch binning (TLPBB). Method 700 may be implemented, for example, using the hardware and/or data flows shown and described with respect to FIGS. 1, 2, 3, 4, 5, and/or 6.

In visibility pass 702, a packet processor receives and processes replay control packets, state packets, and draw packets from a packet stream in step 704, to determine render state and draw tokens. The render state and draw tokens are stored in a memory in step 706, and the graphics processing pipeline is configured with the render state in step 708. Visibility information is determined by executing the draw calls with the graphics processing pipeline, as configured with the render state, in step 710.

In render pass 712, the packet processor receives and processes replay control packets, state packets, and draw packets from the shadow memory/cache in step 704, to discard or ignore the state packets, and to modify the draw packets based on the visibility information determined in the visibility pass. The render state and draw tokens are retrieved from the memory in step 714, and the graphics processing pipeline is configured with the retrieved render state in step 716. The modified draw calls are executed by the graphics processing pipeline, as configured with the render state, in step 718.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, the SIMD units 138, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for rendering primitives in a frame, the method comprising:
during a visibility pass, processing state packets to determine a register state, and storing the register state in a memory device; and
during a rendering pass, reading the register state from the memory device.

2. The method of claim 1, further comprising:
configuring a graphics pipeline during the visibility pass based on the register state determined by processing the state packets; and
configuring the graphics pipeline during the rendering pass based on the register state read from the memory device.

3. The method of claim 1, further comprising:
processing replay control packets, draw packets, and the state packets, from a packet stream, during the visibility pass; and
modifying the draw packets based on visibility information determined during the visibility pass and processing the replay control packets, during the rendering pass.

4. The method of claim 1, wherein the register state is stored in an encoded format.

5. The method of claim 1, wherein the register state is stored in a compressed format.

6. The method of claim 1, wherein the register state is stored in a cache memory or random-access memory (RAM).

7. The method of claim 1, wherein the state packets are processed to determine the register state by a packet processor, and the packet processor sends the register state to acceleration hardware for storage in the memory device.

8. A graphics processing device configured to render primitives in a frame, the graphics processing device comprising:
circuitry configured to, during a visibility pass, process state packets to determine a register state, and store the register state in a memory device; and
circuitry configured to, during a rendering pass, read the register state from the memory device.

9. The graphics processing device of claim 8, further comprising:
circuitry configured to configure a graphics pipeline during the visibility pass based on the register state determined by processing the state packets; and
circuitry configured to configure the graphics pipeline during the rendering pass based on the register state read from the memory device.

10. The graphics processing device of claim 8, further comprising:
circuitry configured to process replay control packets, draw packets, and the state packets, from a packet stream, during the visibility pass; and
circuitry configured to modify the draw packets based on visibility information determined during the visibility pass, and to process modified draw packets and the replay control packets, during the rendering pass.

11. The graphics processing device of claim 8, further comprising circuitry configured to encode the register state and to store the register state in an encoded format.

12. The graphics processing device of claim 8, further comprising circuitry configured to compress the register state and to store the register state in a compressed format.

13. The graphics processing device of claim 8, further comprising circuitry configured to store the register state in a cache memory or random-access memory (RAM).

14. The graphics processing device of claim 8, further comprising circuitry configured to process the state packets to determine the register state, and circuitry configured to send the register state to acceleration hardware for storage in the memory device.

15. An acceleration device comprising:
circuitry configured to, during a visibility pass, receive register state from a packet processor, and to store the register state in a memory device; and
circuitry configured to, during a rendering pass, read the register state from the memory device.

16. The acceleration device of claim 15, further comprising:
circuitry configured to configure a graphics pipeline during the visibility pass based on the register state received from the packet processor; and
circuitry configured to configure the graphics pipeline during the rendering pass based on the register state read from the memory device.

17. The acceleration device of claim 15, further comprising:
circuitry configured to send register state received from the packet processor to a graphics pipeline during the visibility pass; and
circuitry configured to send register state read from the memory device to the graphics pipeline during the rendering pass.

18. The acceleration device of claim 15, further comprising circuitry configured to encode the register state and to store the register state in an encoded format.

19. The acceleration device of claim 15, further comprising circuitry configured to compress the register state and to store the register state in a compressed format.

20. The acceleration device of claim 15, further comprising circuitry configured to store the register state in a cache memory or random-access memory (RAM).
